(19) United States
(12) Patent Application Publication
(10) Pub. No.: US 2015/0324855 A1
(43) Pub. Date: Nov. 12, 2015

(54) METHOD AND SYSTEM FOR PROVIDING ADVERTISEMENT TO A USER OF A COMMUNICATION NETWORK

(71) Applicant: TELECOM ITALIA S.P.A., Milano (IT)

(72) Inventors: Gabriele Elia, Torino (IT); Marco Marchetti, Torino (IT); Giovanni Martini, Torino (IT)

(73) Assignee: Telecom Italia S.p.A., Milano (IT)

(21) Appl. No.: 14/651,163

(22) PCT Filed: Dec. 14, 2012
(86) PCT No.: PCT/EP2012/075550

§ 371 Date: Jun. 10, 2015

(51) Int. Cl. G06Q 30/02; G06F 17/30

(52) U.S. Cl. CPC G06Q 30/0267; G06F 17/30876

(57) ABSTRACT

Disclosed is a method for providing advertisement to a user of a communication network. An advertisement database stores an association between the identifier of a further user and at least one visual advertisement associated with and selected by the further user. When a communication session is set up in the communication network between the user and the further user, an advertisement manager uses the identifier of the further user for retrieving from the advertisement database a visual advertisement selected amongst the visual advertisements associated with the further user. The advertisement manager then transmits the selected visual advertisement to the user for display on a display of the user device.

### TECHNICAL FIELD

The present invention relates to the field of communication services. In particular, the present invention relates to a method and system for providing advertisement to a user of a communication network.

### BACKGROUND ART

It is known providing advertisements to users of communication services offered by communication networks. In particular, in case of mobile call services, the known in-call advertising technique provides for sending to a calling user a voice advertisement, which the calling user shall listen to before the call is set up. In return for the attention that she/he paid to the voice advertisement, the user is economically rewarded, e.g. with a service fee reduction or a credit.

WO 2007/053928 concerns an apparatus and a method for supplying sponsored advertising to a wireless telephone user in a wireless communication network. The advertiser pays part of the cost of the call initiated by a subscribed after listening to the advertiser's advertisement. Advertisers are provided with information of users and their habits in order to offer the users advertisements relating to products and services of their interest.

WO 2007/130992 relates to a method for making telephone calls whereby advertisers sponsor free calling minutes to telephone customers. Advertisers are allowed to insert audio, text and video advertising in an active telephone connection, typically at the beginning of a circuit connection. A statistical method is exploited to identify and target customers with advertisements based on profiles and past calling activities.

### SUMMARY OF THE INVENTION

The Applicant has perceived that the above in-call advertising techniques exhibit some drawbacks.

First of all, listening to a voice advertisement before being connected to the called user may be quite inconvenient and annoying for the calling user, especially if she/he has a rush to speak with the called user.

Moreover, in the above cited in-call advertising techniques, the advertisements provided to the calling user are statistically selected based on information (age, sex, profession, hobbies, etc.) provided by the user and allowing to reconstruct a user's profile. However, even if a user belongs to a certain user's profile, this does not guarantee that she/he is actually interested in a certain type of product or service. Hence, the advertisements received by a user may relate to services or products which are indeed of little interest or no interest at all to her/him, in spite of being classified as “of interest” for her/his user's profile. This induces the user to pay little attention to the advertisement, which accordingly is virtually ineffective.

In view of the above, the Applicant has tackled the problem of providing a method and system for providing advertisement to a user of a communication network, which allows reducing the impact of the advertisement and increasing the attention that the user pays to the received advertisement.

In the present description and in the claims, the expression “communication service” will include any service providing the setting up of a one-to-one communication session between two users. A communication service may include for instance a mobile call service, a VoIP call service (e.g. Skype) or an instant messaging service (e.g. Windows Live Messenger or Google Talk).

Further, in the present description and in the claims, the term “identifier” will indicate information which uniquely identifies the user within the framework of a certain communication service. For instance, in case of a mobile call service, the identifier is the user's IMSI/MSISDN; in case of a VoIP call service or instant messaging service, the identifier is the user's name, account or email address (e.g. Skype name, Microsoft account or Gmail address).

According to a first aspect, the present invention provides a method for providing advertisement to a user of a communication network, the method comprising:

(a) at an advertisement database, storing an association between an identifier of a further user of the communication network and at least one visual advertisement;

(b) setting up a communication session in the communication network between a user device of the user and a further user device of the further user;

(c) at an advertisement manager, using the identifier of the further user for retrieving from the advertisement database a visual advertisement selected amongst the at least one visual advertisement; and

(d) transmitting the selected visual advertisement from the advertisement manager to the user device of the user, the selected visual advertisement being displayed on a display of the user device.

Preferably:
step (a) further comprises storing a further association between a further identifier of the user and at least one further visual advertisement;
step (c) further comprises using the further identifier of the user for retrieving a further visual advertisement selected amongst the at least one further visual advertisement associated with the user; and
step (d) further comprises transmitting the further selected visual advertisement from the advertisement manager to the further user device of the further user, the further selected visual advertisement being displayed on a display of the user device.

Preferably, step (b) comprises transmitting a communication session set up request from the user device to the further user device.

According to a first embodiment, step (b) further comprises transmitting an advertisement request from the user device to the advertisement manager, the advertisement request comprising the identifier of the further user.

Preferably, the advertisement request is automatically transmitted by the user device to the advertisement manager before the communication session set up request is transmitted by the user device to the further user device.

Preferably, the selected visual advertisement is transmitted from the advertisement manager to the user device before the communication session set up request is transmitted by the user device to the further user device.

Preferably, the user device automatically displays the selected visual advertisement as it receives it from the advertisement manager, within a graphic interface through which the user is waiting that the communication session is set up.

Preferably, step (b) further comprises transmitting a further advertisement request from the further user device to the advertisement manager upon reception of the communication session set up request at the further user device, the further advertisement request comprising the further identifier of the user.

According to preferred variants, at step (c) the visual advertisement is retrieved after the further advertisement request is received at the advertisement manager.

Optionally, at step (c) the visual advertisement is retrieved based on information of the user retrieved from a contact list of the further user and comprised in the further advertisement request, the information of the user comprising a contact group to which the user belongs in the contact list of the further user.

According to a second embodiment:
step (b) comprises storing information on the communication session at a further database cooperating with the communication network, the information comprising the identifier of the further user; and
step (c) comprises retrieving the identifier of the further user from the further database.

Preferably, the selected visual advertisement is transmitted to the user device during the communication session or after the communication session is closed.

Preferably, the selected visual advertisement is stored at the user device and is available for being displayed by the user device on the user's initiative.

Preferably, the at least one visual advertisement comprises a banner in turn comprising at least one image and/or at least one text word and/or at least one link to a web page.

According to a second aspect thereof, the present invention provides a communication system configured to provide advertisement to a user, the communication system comprising:
a communication network configured to support a communication session between a user device of the user and a further user device of a further user;
an advertisement database storing an association between an identifier of the further user and at least one visual advertisement associated with the further user; and
an advertisement manager configured to, upon setting up of the communication session, use the identifier of the further user for retrieving from the advertisement database a visual advertisement selected amongst the at least one visual advertisement associated with the further user and transmit the selected visual advertisement to the user device of the user, the visual advertisement being displayed on a display of the user device.

### BRIEF DESCRIPTION OF THE DRAWINGS

The present invention will become clearer from the following detailed description, given by way of example and not of limitation, to be read with reference to the accompanying drawings, wherein:

FIG. 1 schematically shows a communication system according to a first embodiment of the present invention;

FIG. 2 is a first time diagram relating to the operation of the system of FIG. 1;

FIG. 3 shows a table stored in a database comprised in the system of FIG. 1;

FIG. 4 is a second time diagram relating to the operation of the system of FIG. 1;

FIG. 5 shows the calling device and the called device after the steps of FIG. 4 have been carried out;

FIG. 6 schematically shows a communication system according to a second embodiment of the present invention; and

FIG. 7 shows a time diagram relating to the operation of the system of FIG. 6.

### DETAILED DESCRIPTION OF PREFERRED EMBODIMENTS OF THE INVENTION

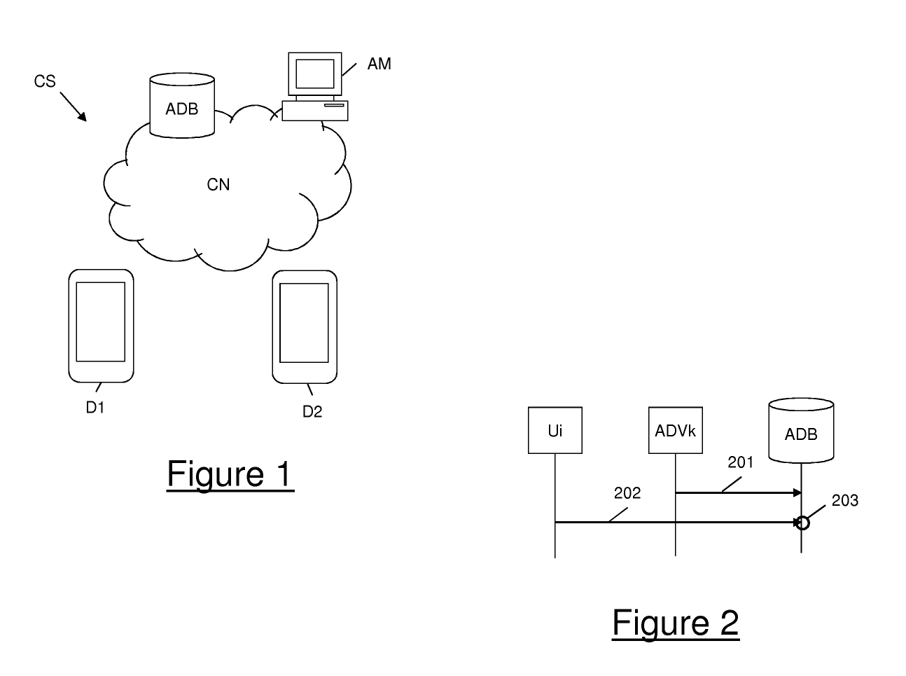

FIG. 1 schematically shows a communication system CS according to a first embodiment of the present invention.

The communication system CS comprises a communication network CN and at least two user devices D1, D2 suitable for enabling respective users U1, U2 (not shown in FIG. 1) to communicate via the communication network CN.

The communication network CN preferably comprises a mobile or fixed telephone network and/or a wireless or wired data network. For instance, the communication network CN may comprise a UMTS/LTE network and an IP network. The communication network CN is preferably configured to support a communication service allowing the user devices D1, D2 to be reciprocally connected by setting up a one-to-one communication session involving the user devices D1, D2 upon request of any of the users U1, U2. The communication service may be for instance a mobile call service, a VoIP call service, an instant messaging service, and so on.

The user devices D1, D2 are in turn configured to access such communication service. For instance, in case of a mobile call service, each user device D1, D2 is equipped with a respective mobile interface comprising a suitable hardware supporting connection to mobile stations of the communication network CN and a suitable software configured to manage the set up of mobile calls. The user devices D1, D2, which are preferably provided of respective displays, may be cellular phones, smart phones, tablets, personal computers, and so on. The user devices D1, D2 may of a same type or of different types (for instance, a smart phone and a tablet).

Preferably, each user U1, U2 is provided with a respective identifier Id1, Id2 which she/he uses for accessing and using the communication service. For instance, in case the communication service is a mobile call service, the identifiers Id1, Id2 of the users U1, U2 may be their IMSI/MSISDNs. In case the communication service is a VoIP call service or an instant messaging service, the identifiers Id1, Id2 of the users U1, U2 may be their names or accounts or email addresses.

The communication system CS further preferably comprises an advertisement manager AM and an advertisement database ADB cooperating with the communication network CN.

With reference now to FIG. 2, according to preferred embodiments of the present invention, at least one advertiser ADVk loads on the advertisement database ADB an advertisement Ak (step 201). The advertisement Ak preferably is a visual advertisement. For instance, the advertisement Ak may be in the form of a file comprising at least one image and/or at least one text word and/or at least one link to a web page (e.g. the advertiser page, a personal blog, etc.), the image and/or text word and/or link being suitable for being shown within a banner. The advertisements Ak loaded by the various advertisers on the advertisement database ADB are preferably made available to users who successively register at the advertisement database ADB.

In particular, a user Ui of the communication service provided by the communication network CN may register at the advertisement database ADB by providing its own identifier Idi and by selecting one or more advertisements amongst the advertisements Ak available at the advertisement database ADB (step 202). Optionally, for each selected advertisement, the user may also specify at least one contact group (e.g. friends, family, business, etc.) to which the selected advertisement is addressed, as it will be discussed in detail hereinafter. It shall be noticed that, according to the present invention, during the registration step 202 the user Ui is not required to provide any personal information (for instance name, sex, age, address, profession, etc.), in addition to the identifier uniquely identifying him/her within the framework of the communication service. During the registration step 202, the user Ui also preferably gives her/his consent to receive advertisements from the advertisement database ADB.

According to alternative embodiments, during the registration step 202 the user may provide her/his identifiers and, instead of explicitly selecting the advertisements amongst the available ones, she/he may implicitly provide them. For instance, if the user has joined a social network (e.g. Facebook), the user may request an automatic recovery of the advertisements to be associated with her/his identifier based on her/his “like pages”.

The user Ui may carry out the registration step 202 by her/his user device or by another device. Registration may be performed e.g. by sending an SMS, using dedicated client software or accessing a dedicated web page.

After the user Ui has completed the registration step 202, the advertisement database ADB preferably stores an association between her/his identifier and the advertisement(s) selected by the user Ui during the registration step 202 (step 203).

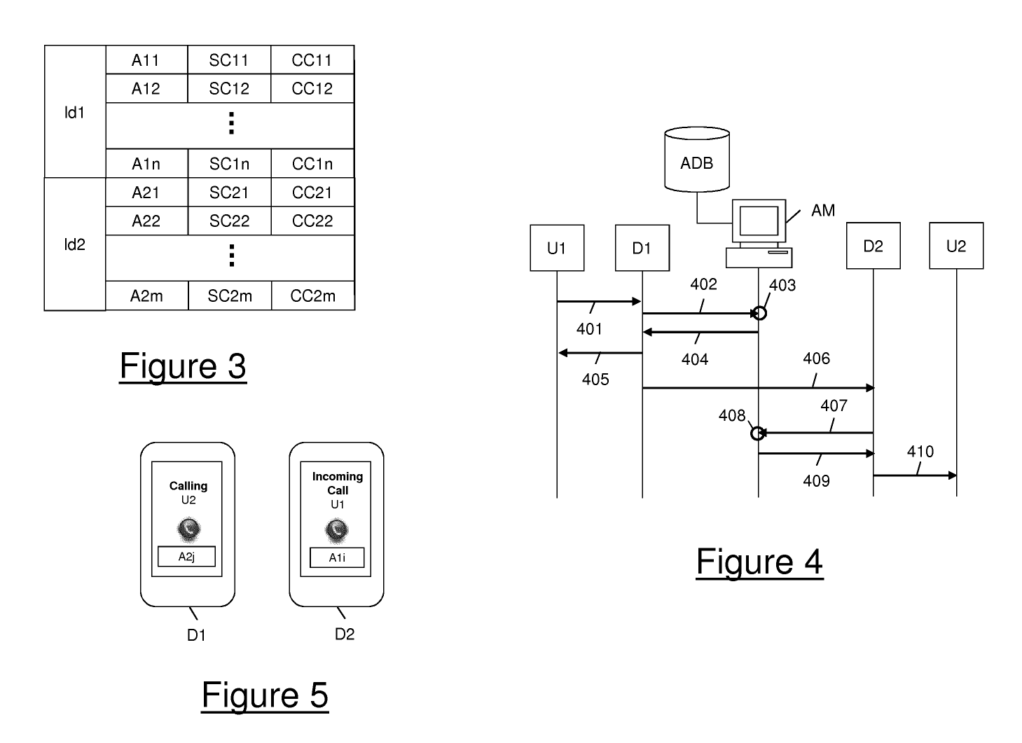

For instance, with reference to FIG. 3, it is assumed that the user U1 registers at the advertisement database ADB by providing her/his own identifier Idi and by selecting a number n of advertisements A11, A12, . . . A1n amongst the advertisements Ak available at the advertisement database ADB. Further, also the user U2 registers at the advertisement database ADB by providing her/his own identifier Id2 and by selecting a number m of advertisements A21, A22, . . . A2m amongst the advertisements Ak available at the advertisement database ADB. Hence, the advertisement database ADB preferably stores:

an association between the identifier Id1 of the user U1 and the number n of advertisements A11, A12, . . . A1n; and

an association between the identifier Id2 of the user U2 and the number m of advertisements A21, A22, . . . A2m.

According to preferred embodiments, the advertisement database ADB also preferably stores, for each advertisement associated with a given identifier, a respective first counter (also termed herein after “show counter”), whose function and use will be better detailed in the following. For instance, as shown in FIG. 3, the advertisement database ADB preferably stores:

a number n of show counters SC11, SC12, . . . SC1n (one for each advertisement A11, A12, . . . A1n); and

a number m of show counters SC21, SC22, . . . SC2m (one for each advertisement A21, A22, . . . A2m).

According to still preferred embodiments, the advertisement database ADB also preferably stores, for each advertisement associated with a given identifier, a respective second counter (also termed herein after “click counter”), whose function and use will be better detailed in the following. For instance, as shown in FIG. 3, the advertisement database ADB preferably stores:

a number n of click counters CC11, CC12, . . . CC1n (one for each advertisement A11, A12, . . . A1n); and

a number m of click counters CC21, CC22, . . . CC2m (one for each advertisement A21, A22, . . . A2m).

With reference now to FIG. 4, it is assumed that one of the users (also termed herein after for simplicity “calling user”) of the communication service provided by the communication network CN wishes to communicate with another user (also termed herein after for simplicity “called user”). At least one of the calling user and the called user is preferably registered at the advertisement database ADB. More preferably, both the calling user and the called user are registered at the advertisement database ADB. Herein after, it is assumed that U1 is the calling user and U2 is the called user.

Firstly, the calling user U1 preferably accesses her/his contact list through the user device D1 and selects therefrom the called user U2 (step 401). The contact list preferably is a list of all the users which may be reached through the communication service. For instance, in case of a mobile call service, the contact list is the telephone book stored by the user device D1 and/or a SIM card plugged in the user device D1. Alternatively, if the called user U2 is not within the contact list of the calling user U1, at step 401 the calling user U1 may manually enter the identifier Id2 of the called user U2.

As the calling user U1 selects the called user U2 from her/his contact list (or manually enters her/his identifier Id2), the user device D1 preferably automatically sends a calling advertisement request to the advertisement manager AM via the communication network CN (step 402). The calling advertisement request preferably comprises the identifier Id2 of the called user U2 (e.g. it's IMSI/IMEI, in case of a mobile call service). The calling advertisement request may be for instance an http request sent via the data network comprised in the communication network CN.

As the advertisement manager AM receives the calling advertisement request, it preferably retrieves therefrom the identifier Id2 of the called user U2 and preferably selects in the advertisement database ADB one of the m advertisements A21, A22, . . . A2m associated with the identifier Id2 of the called user U2 (step 403). The selected advertisement A2j may be selected either in a random way or according to predefined criteria. During step 403, the advertisement manager AM also preferably increases by one the “show counter” of the selected advertisement A2j. For instance, if the selected advertisement A2j is A22, the advertisement manager AM preferably increases by one the show counter SC22. This way, each show counter SC21, SC22, . . . SC2m counts the number of times the respective advertisement A21, A22, . . . A2m is visualized by users calling or called by the user U2. The user U2 may be accordingly rewarded.

Then, the advertisement manager AM preferably generates a calling advertisement response and sends it to the user device D1 of the calling user U1 via the communication network CN (step 404). The calling advertisement response preferably comprises the selected advertisement A2j. The calling advertisement response may be transmitted based on the http protocol (http GET). Alternatively, an http-push technique (such as Ajax or XMPP—Extensible Messaging and Presence Protocol) may be employed.

As the user device D1 of the calling user U1 receives the calling advertisement response, it preferably automatically retrieves therefrom the selected advertisement A2j and displays it on the user device display (step 405), so that the calling user U1 may see its content. As mentioned above, each advertisement (including the selected advertisement A2j) preferably is a visual advertisement such as a banner comprising at least one image and/or at least one text word and/or at least one link to a web page. The advertisement may include also a sound message, such as a brief sound to signal to the calling user U1 the display of the visual advertisement, or a music or voice message. Hence, at step 405 the user device U1 preferably displays the advertisement A2j on its display within one of the graphic interfaces of the communication service which the calling user U1 is requesting to access for communicating with the called user U2.

For instance, in a case that the communication service is a mobile call service, the advertisement A2j is preferably visualized on the display within an outgoing call graphic interface of the user device D1, as schematically shown in FIG. 5. Hence, while the calling user U1 is waiting to be connected to the called user U2, she/he is presented with one of the m advertisements A21, A22, . . . A2m selected by the called user U2.

If the advertisement A2j comprises a link, the calling user U1 may also click the link and access e.g. an advertiser web page. The calling user U1 may click the link during the communication session (e.g. in case the user device D1 is a PC and the communication session is a VoIP session or instant messaging session) or after the communication session (e.g. in case the user device D1 is a smartphone and the communication session is a mobile call session). In the latter case, the advertisement A2j should preferably persist on the display of the user device D1 until expiration of a predefined time after closing of the communication session. As the calling user U1 clicks the link of the advertisement A2j, this event is notified via the communication network CN to the advertisement manager AM, which preferably increases by one the “click counter” associated with the advertisement A2j. For instance, if the selected advertisement A2j is A22 and the calling user U1 clicks it, the advertisement manager AM preferably increases by one the click counter CC22. This way, each click counter CC21, CC22, . . . CC2m counts the number of times the respective advertisement A21, A22, . . . A2m is clicked by users calling or called by the user U2. The user U2 may be accordingly rewarded.

While the selected advertisement A2j is being displayed by the user device D1, the user device D1 also sends a communication session set up request to the called device D2 via the communication network CN (step 406). The communication session set up request comprises the identifier Id1 of the calling user U1.

As the user device D2 of the called user U2 receives the communication session set up request from the user device D1 of the calling user U1, the user device D2 preferably sends a called advertisement request to the advertisement manager AM via the communication network CN (step 407). Optionally, at step 407, the user device firstly checks whether the identifier Id1 of the calling user U1 is comprised in the contact list of the called user U2 and, in the affirmative, sends the called advertisement request. The called advertisement request preferably comprises the identifier Id1 of the calling user U1 (e.g. it's IMSI/IMEI, in case of a mobile call service). The called advertisement request may be for instance an http request sent via the data network comprised in the communication network CN.

As the advertisement manager AM receives the called advertisement request, it preferably retrieves therefrom the identifier Id1 of the calling user U1 and preferably selects in the advertisement database ADB one of the n advertisements A11, A12, . . . A1n associated with the identifier Id1 of the calling user U1 (step 408). The selected advertisement A1i may be selected either in a random way or according to predefined criteria. During step 408, the advertisement manager AM also preferably increases by one the show counter of the selected advertisement A1i. For instance, if the selected advertisement A1i is A12, the advertisement manager AM preferably increases by one the show counter SC12. This way, each show counter SC11, SC12, . . . SC1n counts the number of times the respective advertisement A11, A12, . . . A1n is visualized by users calling or called by the user U1. The user U1 may be accordingly rewarded.

Then, the advertisement manager AM preferably generates a called advertisement response and sends it to the user device D2 of the called user U2 via the communication network CN (step 409). The called advertisement response preferably comprises the selected advertisement A1i. The called advertisement response may be transmitted based on the http protocol (http GET). Alternatively, an http-push technique (such as Ajax or XMPP—Extensible Messaging and Presence Protocol) may be employed.

As the user device D2 of the called user U2 receives the called advertisement response, it preferably automatically retrieves therefrom the selected advertisement A1i and displays it on the user device display (step 410), so that the called user U2 may see its content. As mentioned above, each advertisement (including the selected advertisement A1i) preferably is a visual advertisement such as a banner comprising at least one image and/or at least one text word and/or at least one link to a web page. The advertisement may include also a sound message, such as a brief sound to signal to the called user U2 the display of the visual advertisement, or a music or voice message. Hence, at step 410 the user device U2 preferably displays the advertisement A1i within one of the graphic interfaces of the communication service which the calling user U1 is requesting to access for communicating with the called user U2.

For instance, in a case that the communication service is a mobile call service, the advertisement A1i is preferably visualized on the display within an incoming call graphic interface of the user device D2, as schematically shown in FIG. 5. Hence, while the called user U2 is deciding whether to accept the call from the calling user U1, she/he is presented with one of the n advertisements A11, A12, . . . A1n selected by the calling user U1.

If the advertisement A1i comprises a link, the called user U2 may also click the link and access e.g. an advertiser web page. The called user U2 may click the link during the communication session (e.g. in case the user device D2 is a PC and the communication session is a VoIP session or instant messaging session) or after the communication session (e.g. in case the user device D2 is a smartphone and the communication session is a mobile call session). In the latter case, the advertisement A1i should preferably persist on the display of the user device D2 until expiration of a predefined time after conclusion of the communication session. As the called user U2 clicks the link of the advertisement A1i, this event is notified via the communication network CN to the advertisement manager AM, which preferably increases by one the click counter associated with the advertisement A1i. For instance, if the selected advertisement A1i is A12 and the called user U2 clicks it, the advertisement manager AM preferably increases by one the click counter CC12. This way, each click counter CC11, CC12, . . . CC1n counts the number of times the respective advertisement A11, A12, . . . A1n is clicked by users calling or called by the user U1. The user U1 may be accordingly rewarded.

Hence, according to embodiments of the present invention, each user U1, U2 involved in a one-to-one communication session is presented with one of the advertisements selected by the other user involved in the same one-to-one communication session. In other words, according to the present invention two users U1, U2 involved in a one-to-one communication session basically exchange advertisements according to a social advertisement mechanism. The advertisement manager AM acts as an advertisement broker which mediates the exchange of advertisements between users.

This advantageously increases the interest that an advertisement raises in the user who receives it. Indeed, the user knows that the displayed advertisement was chosen by the other user, who is a person she/he knows and trusts more than an abstract entity statistically selecting advertisements based on an alleged user's profile. The advertisement is accordingly more effective, because the user knows that it relates to a product or service appreciated by her/his contact and is accordingly more inclined to consider its content.

Further, the user is advantageously more inclined to register at the advertisement database ADB since, as mentioned above, she/he does not have to provide any personal information such as name, sex, age, profession, hobbies, etc. Such personal information is indeed unneeded because the advertisement selection performed by the advertisement manager AM is based exclusively on the identifiers of the users involved in the one-to-one communication session. The user's privacy is accordingly highly protected.

On the other hand, the advertisement is much less intrusive than a voice advertisement. Indeed, while listening to a voice advertisement takes a predefined time equal to the advertisement duration (which is selected by the advertiser), according to the present invention the user may decide how much time she/he wants to dedicate to the visual advertisement. The user may decide to give it a cursory glance, which may take only few moments. Alternatively, the user may carefully read the banner, which may take a longer time. Otherwise, if the user is actually interested in the advertised product or service, she/he may click the banner and visit the related web page. Hence, according to the actual interest raised by the advertisement, the user is advantageously free to decide how much time she/he will dedicate to it.

According to variants not shown in the drawings, the advertising manager AM may send the calling advertisement response (step 404) and the called advertisement response (step 409) using an asynchronous communication channel (for instance, SMS or MMS) supported by the communication network CN and by the user devices D1, D2. In other words, the transmission of the calling/called advertisement response is not synchronized with the communication session set up and may be performed e.g. after the communication session has been set up. As the user device D1 of the calling user U1 receives the calling advertisement response, the calling user U1 may open it and visualize the advertisement A2j at her/his convenience, for instance during the communication session (e.g. in case of a VoIP session or an instant messaging session) or after the communication session with the called user U2 is closed (e.g. in case of a mobile call session). Similarly, as the user device D2 of the called user U2 receives the called advertisement response, the called user U2 may open it and visualize the advertisement A1i at her/his convenience, for instance during the communication session (e.g. in case of a VoIP session or an instant messaging session) or after the communication session with the called user U2 is closed (e.g. in case of a mobile call session). If advertisement A2j and/or the advertisement A1i is opened and visualized during a voice communication session and includes a sound, music or voice message, the sound, music or voice message is preferably at a volume such as not to interfere with the ongoing voice communication between the users U1, U2.

According to other variants not shown in the drawings, the advertisements manager AM preferably selects both the advertisements A2j and A1i (steps 403 and 408 of FIG. 4, respectively) after it has received both the calling advertisement request from the user device D1 of the calling user U1 (step 402) and the called advertisement request from the user device D2 of the called user U2 (step 407), and then send the calling advertisement response (step 404) and the called advertisement response (step 409) using the above mentioned asynchronous communication channel (for instance, SMS or MMS) supported by the communication network CN and by the user devices D1, D2.

According to such variants, the advertisement manager AM may advantageously select at least one of the advertisements A2j and A1i using also information derived from the contact lists of the users U1, U2. For instance, during the registration phase 202 shown in FIG. 2, each user Ui may specify, for each selected advertisement, at least one contact group (e.g. friends, family, business, etc.) to which that advertisement is addressed. When the user device D1 of the calling user U1 sends the calling advertisement request to the advertising manager AM (step 402), the request comprises, in addition to the identifier Id2 of the called user U2, also an identifier GCId2 of the contact group to which the called user U2 belongs within the contact list of the calling user U1. Similarly, when the user device D2 of the called user U2 sends the called advertisement request to the advertising manager AM (step 407), the request comprises, in addition to the identifier Id1 of the calling user U1, also an identifier GCId1 of the contact group to which the calling user U1 belongs within the contact list of the called user U2. As the advertisement manager AM selects the advertisement A2j to be sent to the calling user U1 (step 403), it preferably considers amongst all the advertisements A21, A22, . . . A2m only those advertisements which the called user U2 has indicated as intended to the contact group CGId1 to which the calling user U1 belongs within the contact list of the called user U2. Similarly, as the advertisement manager AM selects the advertisement A1i to be sent to the called user U2 (step 408), it preferably considers—amongst all the advertisements A11, A12, . . . A1n—only those advertisements which the calling user U1 has indicated as intended to the contact group CGId2 to which the called user U2 belongs within the contact list of the calling user U1.

According to further variants, the contact lists of the users U1, U2 may be centrally stored within a database (namely, the advertisement database ADB or a separate dedicated database) accessible by the advertisement manager AM. According to such variants, the identifier GCId1 of the contact group to which the calling user U1 belongs within the contact list of the called user U2 and the identifier GCId2 of the contact group to which the called user U2 belongs within the contact list of the calling user U1 are preferably centrally stored at such database. This information therefore does not need to be inserted in the called advertisement request and calling advertisement request, respectively. Hence, as the advertisement manager AM receives the calling advertisement request, it may select the advertisement A2j amongst those advertisements which the called user U2 has indicated as intended to the contact group CGId1 by using the centrally stored information, without the need to wait for the called advertisement request, as shown in the flow chart of FIG. 4.

Further, according to other embodiments, only one of the calling user U1 and the called user U2 may be registered at the advertisement database ADB. Assuming e.g. that only the calling user U1 is registered (and has accordingly selected her/his advertisements A11, A12, . . . A1n), as the advertisement manager AM receives the calling advertisement request comprising the identifier Id2 of the called user Id2 (step 402), the advertisement manager AM determines that the called user Id2 is not registered at the advertisement database ADB, and that accordingly there are no advertisements available which may be sent to the calling user U1. Hence, steps 403, 404 and 405 are omitted. On the other hand, as the advertisement manager AM receives the called advertisement request comprising the identifier Id1 of the calling user Id1 (step 407), the advertisement manager AM determines that the calling user Id1 is registered at the advertisement database ADB, and accordingly selects the advertisement A1i amongst the advertisements A11, A12, . . . A1n (step 408) and sends it to the user device D2 of the called user U2. Hence—provided that the called user U2, although not registered at the advertisement database ADB, has provided her/his authorization to receive advertisements therefrom—the called user U2 may receive an advertisement selected by the calling user U1.

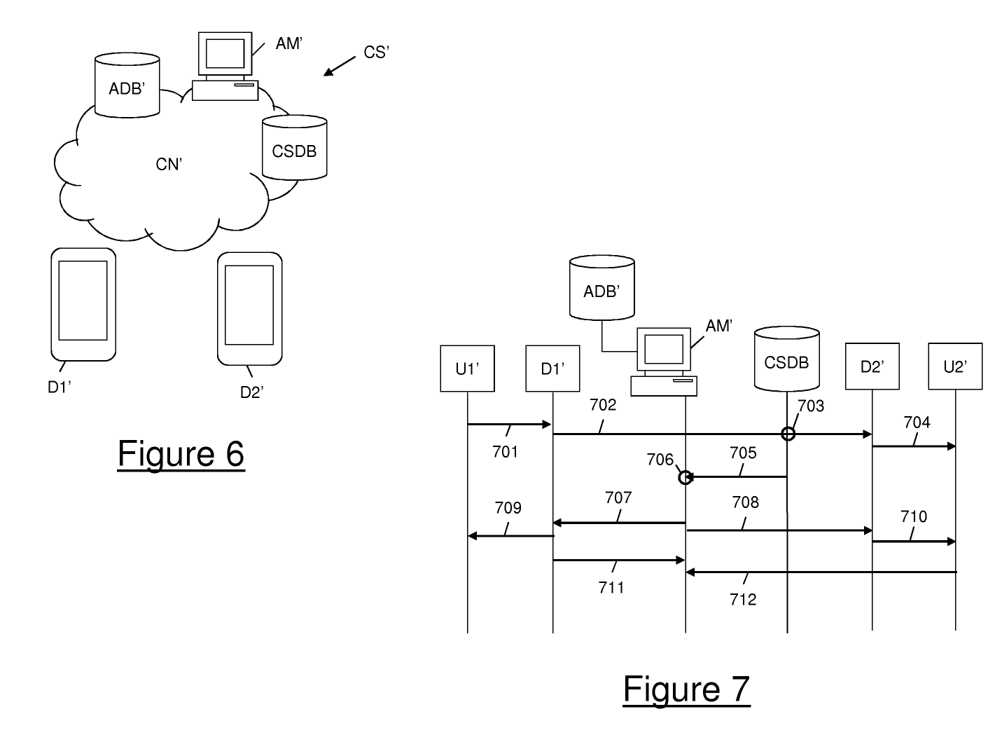

FIG. 6 shows a communication system CS′ according to a second embodiment of the present invention.

The communication system CS′ comprises a communication network CN′, at least two user devices D1′, D2′ suitable for enabling respective users U1′, U2′ (not shown in FIG. 6) to communicate via the communication network CN′, an advertisement database ADB′ and an advertisement manager AM′. The network CN′, the devices D1′, D2′, the database ADB′ and the manager AM′ are substantially similar to the network CN, the devices D1, D2, the database ADB and the manager AM shown in FIG. 1. Hence, a detailed description will not be repeated.

In addition, the communication system CS′ according to the second embodiment comprises a communication session database CSDB cooperating with the communication network CN′. The communication session database CSDB preferably stores information about events relating to one-to-one communication sessions occurring in the communication network CN (e.g. log files). In particular, the database CSDB preferably stores the identifiers of calling user and called user of each requested communication session, as it will be described in detail herein after. The communication session database CSDB preferably is the log of the operator of the communication network CN.

Similarly to the advertisement database ADB of FIG. 1, also the advertisement database ADB′ according to the second embodiment stores advertisements Ak loaded by a number of advertisers. Further, at least one user of the communication service supported by the communication network CN′ may register at the advertisement database ADB′ by providing her/his identifier and selecting (explicitly or implicitly, as described above) one or more advertisements amongst the advertisements Ak available at the advertisement database ADB′. The advertisement loading procedure and the user registration procedure shown in FIG. 2 still apply also to the advertisement database ADB′ according to the second embodiment. Hence, a detailed description thereof will not be repeated.

With reference now to FIG. 7, it is assumed that a calling user wishes to communicate with a called user. At least one of the calling user and the called user is preferably registered at the advertisement database ADB′. More preferably, both the calling user and the called user are registered at the advertisement database ADB′. Herein after, it is assumed that U1′ is the calling user and U2′ is the called user.

Firstly, the calling user U1′ preferably accesses her/his contact list through the user device D1 and selects therefrom the called user U2′ (step 701). The contact list preferably is a list of all the users which may be reached by the communication service. For instance, in case of a mobile call service, the contact list is the telephone book stored by the user device D1′ and/or a SIM card plugged in the user device D1′. Alternatively, if the called user U2′ is not within the contact list of the calling user U1′, at step 701 the calling user U1′ may manually enter the identifier Id2′ of the called user U2′.

As the calling user U1′ selects the called user U2′ from her/his contact list (or manually enters her/his identifier Id2′), the user device D1′ preferably automatically sends a communication session set up request to the user device D2′ via the communication network CN′ (step 702). The communication session set up request comprises the identifier of the calling user Id1′ and the identifier of the called user Id2′ (for instance, their IMSI/IMEIs, in case of a mobile call service).

During step 702, the communication session database CSDB preferably generates and stores information about the requested communication session, including the identifier Id1′ of the calling user U1′ and the identifier Id2′ of the called user U2′ (step 703).

Upon reception of the communication session set up request, the user device D2′ of the called user U2′ preferably displays a graphic interface for informing the called user U2′ of the incoming request (step 704). By suitably acting upon the graphic interface displayed by the user device D2′, the called user U2′ may either accept or refuse the request.

In any case, as the communication session between the calling user U1′ and the called user U2′ is requested, the advertisement manager AM′ is notified and accordingly retrieves from the communication session database CSDB information on the requested communication session (step 705). In particular, at step 705 the advertisement manager AM retrieves the identifier Id1′ of the calling user U1′ and the identifier Id2′ of the called user U2′. Alternatively to notification, the advertisement manager AM′ may periodically check the communication session database CSDB for information relating to possible new call set up requests. In such case, the advertisement manager AM′ retrieves the information on the requested communication session between the calling user U1′ and the called user U2′ at the first check following the communication set up request. Then, the advertisement manager AM′ preferably selects from the advertisement database ADB′ one A1i′ of n advertisements A11′, A12′, . . . A1n′ associated with the identifier Idt of the calling user U1′ and one A2j′ of m advertisements A21′, A22′, . . . A2m′ associated with the identifier Id2′ of the called user U2′ (step 706). The advertisements A1i′ and A2j′ may be selected either in a random way or according to predefined criteria. During step 707, the advertisement database ADB′ also preferably increases by one the show counters of the selected advertisements A1i′ and A2j′, as described above with reference to FIGS. 3 and 4.

The advertisement manager AM′ then preferably transmits to the user device D1′ of the calling user U1′ a calling advertisement message comprising the selected advertisement A2j′ associated with the identifier Id2′ of the called user U2′ (step 707). Substantially at the same time, the advertisement manager AM′ preferably transmits to the user device D2′ of the called user U2′ a called advertisement message comprising the selected advertisement A1i′ associated with the identifier Id1′ of the calling user U1′ (step 708). At steps 707 and 708, the advertisement manager AM′ preferably transmits the calling advertisement message and the called advertisement message via the communication network CN′, using an asynchronous communication channel (for instance, SMS or MMS) supported by the communication network CN′ and by the user devices D1′, D2′.

As the user device D1′ of the calling user U1′ receives the calling advertisement message, the calling user U1′ may open it and visualize the advertisement A2j′ (step 709) on the display of the user device D1′ at her/his convenience, for instance during the communication session (e.g. in case of a VoIP session or an instant messaging session) or after the communication session with the called user U2′ is closed (e.g. in case of a mobile call session).

Similarly, as the user device D2′ of the called user U2′ receives the called advertisement response, the called user U2′ may open it and visualize the advertisement A1i′ (step 710) on the display of the user device D2′ at her/his convenience, for instance during the communication session (e.g. in case of a VoIP session or an instant messaging session) or after the communication session with the called user U2′ is closed (e.g. in case of a mobile call session).

If advertisement A2j′ and/or the advertisement A1i′ is opened and visualized during a voice communication session and includes a sound, music or voice message, the sound, music or voice message is preferably at a volume such as not to interfere with the ongoing voice communication between the users U1′, U2′.

If the advertisement A2j′ comprises a link to a web page and the calling user U1′ clicks the link, the user device D1′ of the calling user preferably notifies such event to the advertisement manager AM′ (step 711), which accordingly increases by one the click counter of the advertisement A2j′ associated with the identifier Id2′ of the called user U2′ in the advertisement database ADB′. This way, the caller user U2′ may be accordingly rewarded.

Similarly, if the advertisement A1i′ comprises a link to a web page and the called user U2′ clicks the link, the user device D2′ of the called user preferably notifies such event to the advertisement manager AM′ (step 712), which accordingly increases by one the click counter of the advertisement A1i′ associated with the identifier Id1′ of the calling user U1′ in the advertisement database ADB′. This way, the calling user U1′ may be accordingly rewarded.

Hence, also according to this second embodiment, each user U1′, U2′ involved in a one-to-one communication session is presented with one of the advertisements selected by the other user involved in the same one-to-one communication session. However, differently from the first embodiment, the advertisement exchange is autonomously managed in a central way by the advertisement manager AM′ itself, which retrieves information on communication sessions from the communication session database CSDB, uses the retrieved information for accessing the advertisement database ADB′ and sends the selected advertisements to the user devices. Hence, no modification of the software interfaces of the user devices is needed for implementing the second embodiment.

Also this second embodiment exhibits the same advantages as the first embodiment, namely: it increases the interest that the advertisement raises in the user, since the user is aware that the advertisement relates to a product or service appreciated by her/his contact; the user is more disposed to register at the advertisement database, since she/he does not have to provide any personal information; and the advertisement is much less intrusive than a voice advertisement, since it is a visual advertisement which the user may visualize at her/his convenience even after the communication session is closed.

1. A method for providing an advertisement to a user of a communication network, the method comprising steps of:
at an advertisement database, storing an association between an identifier of a further user of the communication network and at least one visual advertisement associated with the further user;
setting up a communication session in the communication network between a user device of the user and a further user device of the further user;
at an advertisement manager, using the identifier for retrieving from the advertisement database a visual advertisement selected amongst the at least one visual advertisement associated with the further user; and
transmitting the selected visual advertisement from the advertisement manager to the user device of the user, the selected visual advertisement being displayed on a display of the user device.

2. The method according to claim 1, wherein:
the step (a) further comprises storing a further association between a further identifier of the user and at least one further visual advertisement associated with the user;
the step (c) further comprises using the further identifier for retrieving a further visual advertisement selected amongst the at least one further visual advertisement associated with the user; and
the step (d) further comprises transmitting the further selected visual advertisement from the advertisement manager to the further user device of the further user, the further selected visual advertisement being displayed on a display of the further user device.

3. The method according to claim 2, wherein the step (b) comprises transmitting a communication session set up request from the user device to the further user device.

4. The method according to claim 3, wherein the step (b) further comprises transmitting an advertisement request from the user device to the advertisement manager, the advertisement request comprising the identifier of the further user.

5. The method according to claim 4, wherein the advertisement request is automatically transmitted by the user device to the advertisement manager before the communication session set up request is transmitted by the user device to the further user device.

6. The method according to claim 5, wherein the selected visual advertisement is transmitted from the advertisement manager to the user device before the communication session set up request is transmitted by the user device to the further user device.

7. The method according to claim 6, wherein the user device automatically displays the selected visual advertisement as the selected visual advertisement is received from the advertisement manager, within a graphic interface through which the communication session is available to be set up.

8. The method according to claim 4, wherein the step (b) further comprises transmitting a further advertisement request from the further user device to the advertisement manager upon reception of the communication session set up request at the further user device, the further advertisement request comprising the further identifier of the user.

9. The method according to claim 8, wherein the step (c) includes retrieving the visual advertisement after the further advertisement request is received at the advertisement manager.

10. The method according to claim 9, wherein the step (c) includes retrieving the visual advertisement based on information of the user retrieved from a contact list of the further user and included in the further advertisement request, the information of the user comprising a contact group to which the user belongs in the contact list of the further user.

11. The method according to claim 3 wherein:
the step (b) comprises storing information on the communication session at a further database cooperating with the communication network, the information comprising the identifier of the further user; and
the step (c) comprises retrieving the identifier from the further database.

12. The method according to claim 4, wherein the selected visual advertisement is transmitted to the user device during the communication session or after the communication session is closed.

13. The method according to claim 12, wherein the selected visual advertisement is stored at the user device and is available to be displayed by the user device on demand.

14. The method according to claim 1, wherein the at least one visual advertisement comprises a banner comprising at least one of an image, a text word or a link to a web page.

15. A communication system configured to provide an advertisement to a user, the communication system comprising:
a communication network configured to support a communication session between a user device of the user and a further user device of a further user;
an advertisement database storing an association between an identifier of the further user and at least one visual advertisement associated with the further user; and
an advertisement manager configured to, upon setting up of the communication session, use the identifier for retrieving from the advertisement database a visual advertisement selected amongst the at least one visual advertisement associated with the further user and transmit the selected visual advertisement to the user device of the user, the selected visual advertisement being displayed on a display of the user device.
